(19) United States
(12) Patent Application Publication
(10) Pub. No.: US 2009/0202711 A1
(43) Pub. Date: Aug. 13, 2009

(54) COMPOSITION FOR COATING SUBSTRATE TO PREVENT STICKING

(76) Inventors: Casey Lynn Elkins, Bear, DE (US); Robert Harvey Moffett, Landenberg, PA (US); Leonard George Testa, Holden Beach, NC (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/422,757

(22) Filed: Apr. 13, 2009

Related U.S. Application Data
(62) Division of application No. 11/305,933, filed on Dec. 19, 2005.

(51) Int. Cl. B28B 7/38; B29C 33/38; C08L 47/00

(52) U.S. Cl. 427/133; 264/219; 525/105

(57) ABSTRACT

A release agent composition to prevent sticking and facilitate separation of surfaces, such as patterns and core boxes from foundry molds and cores comprises (a) a styrene-diene block copolymer; (b) a functional silicone; (c) a solvent; and optionally, one or both of (d) a catalyst and (e) a crosslinking agent. Further is provided a method to facilitate separation of a workpiece from a substrate comprising applying the release agent composition to a surface of the workpiece, the substrate or both. In one particular embodiment, the method improves the release of a mold or a core from a pattern or a core box.

### FIELD OF THE INVENTION

This invention relates to a composition that can be used to coat a substrate surface thereby improving the surface function. The composition can be applied generally to substrate surfaces to prevent sticking. In particular, the composition can be used as a release agent for facilitating release of a mold from a pattern or a core from a core box.

### BACKGROUND OF THE INVENTION

Many industrial operations require the use of release agents to reduce the tendency of a molded product to stick to the mold, or, more generally, that of a substrate, such as a tool, die or machine part to stick to the workpiece.

In foundry operations, metal parts are frequently made using “sand casting” methods wherein disposable foundry shapes, such as molds and cores, are fabricated with a mixture of sand and an organic or inorganic binder, sometimes referred to as a “foundry mix”. Molds and cores are produced by chemical or heat hardening of the mixture of sand and binder onto a pattern or core box. Sometimes a catalyst is used to cure the foundry mix more rapidly. A mold release agent is used to reduce or eliminate adhesion of a mold to a pattern or core box surface.

Various processes, such as, for example, the air-set or no-bake process, the carbon dioxide process, the cold box process, hot box process, and similar mold manufacturing processes are well known to those skilled in the art. In these processes, sand and binder mixture is molded upon patterns or in core boxes. The patterns may be constructed from plastic, wood, or metal. Typical metals are aluminum and cast iron. Other materials may also be used.

Mold release agents are typically sprayed or brushed onto a pattern or core box surface periodically during pattern or core preparation. The mold release agent is typically an emulsion or dispersion in a solvent. When dispersed in a solvent, the solvent serves to wet the surface of a shape-determining mold, onto which the release agent is applied.

Silicone resins have been used as lubricants and release agents to prevent the pattern from sticking to the hardened foundry mixture. Silicones often do not, however, coat surfaces well when dispersed in a typical hydrocarbon solvent. The silicone resins are prone to bead or puddle on the surface to which they have been applied, thus preventing a thin, continuous film from being achieved.

It is highly desirable to reuse the same pattern or core box many times, to generate a number of molds or cores from the same pattern or core box. Therefore, it is important for the pattern or core box to be quickly and cleanly released from the finished mold or core with a minimum amount of release agent residue or build up on the pattern, and with minimal need to clean the pattern surface. It is desirable to have an improved mold release agent composition that enables multiple release cycles, especially in foundry processes.

More generally, release agents provide protective coatings and can prevent foreign matter from sticking to surfaces. Release agents can be used to prevent sand, soil and stains from sticking to surfaces. Release agents can also prevent food from sticking to cookware and other surfaces in a typical household. For these reasons, among others, an improved composition for a release agent is desired.

### SUMMARY OF THE INVENTION

This invention is directed to a release agent composition that facilitates separation of patterns and core boxes from foundry molds and cores, castings from molds, and generally, workpieces from substrates, such as dies, tools, and machinery components. The composition also protects surfaces by preventing foreign matter from sticking to surfaces. The composition can also provide a durable coating on the surface of a substrate, that can withstand pressures of at least 40 psi (276 kPa). This invention is also directed to a composition that facilitates cleaning of surfaces, such as concrete, tile, and wood. The composition comprises (a) a styrene-diene block copolymer; (b) a functional silicone; (c) a solvent; and optionally, one or both of (d) a catalyst and (e) a crosslinking agent.

This invention is also directed to a method to facilitate separation of a workpiece from a substrate comprising, applying a release agent composition comprising (a) a styrene-diene block copolymer; (b) a functional silicone; (c) a solvent; and optionally, one or both of (d) a catalyst and (e) a crosslinking agent to a surface of the workpiece, the substrate, or both, to provide a coating on the surface so treated. This invention is also directed to the substrate so coated. The coating is retained when the coating is exposed to pressure of at least 40 psi (276 kPa).

In one particular embodiment, the method is directed at improving the release of a mold removed from a pattern or a core from a core box wherein the method comprises applying a composition comprising (a) a styrene-diene block copolymer; (b) a functional silicone; (c) a solvent; and optionally, one or both of (d) a catalyst and (e) a crosslinking agent to a surface of a pattern or core box, to provide a coating on the surface so treated.

### DETAILED DESCRIPTION OF THE INVENTION

Trademarks and trade names used herein are shown in upper case.

As used throughout this specification and claims, “mold release agent” or simply, “release agent” is used to identify various composition embodiments of this invention having lubricant and abrasion resistant properties that facilitate the clean, low friction separation of a workpiece from a substrate, including patterns from molds, core boxes from cores, castings from molds, cores, and dies, and workpieces from tools and machine components. A workpiece is any object that is molded, stamped, drilled, ground, or otherwise worked upon by a manual or mechanical tool, mold, die, or the like.

The styrene-diene block copolymer comprises polystyrene units and polydiene units. The polydiene units are typically derived from polybutadiene, polyisoprene, or a combination of these two polydienes. The copolymer may be hydrogenated or partially hydrogenated. These materials are usually referred to as SBS, SIS or SEBS and may optionally be functionalized with maleic anhydride. These polymers are commercially available.

The functional silicone is cross-linkable, meaning; a cross-link feature has been designed into its structure. One example of a cross-linkable silicone has an end group derived from a hydroxy group or derivative thereof. The end group allows the silicone to crosslink with a compatible cross-linkable group on another silicone by means of a crosslinking agent.

The functional silicone can be a polyorganosiloxane such as, for example, alkoxy-terminated polyalkylsiloxane, hydroxy-terminated polyorganosiloxane, and combinations of two or more thereof. Examples of polyorganosiloxanes include, but are not limited to, polydimethylsiloxanes, polymethylhydrogensiloxanes, polysilsesquioxanes, polytrimethylsiloxanes, polydimethylcyclosiloxanes, and combinations of two or more thereof which can be methoxy-terminated, hydroxy-terminated, or both.

The functional silicone may also be or comprise a volatile siloxane. The term “volatile siloxane” refers to a siloxane exhibiting volatility (the property of vaporizing readily under given temperature and pressure conditions) under the temperature and pressure of use. Typically, it can have an evaporation rate of more than 0.01 relative to n-butyl acetate which has an assigned value of 1. A volatile siloxane can have the formula of R¹(R¹₂SiO)ₓSiR¹₃ or (R¹₂SiO)_{y} where each R¹ can be the same or different and can be an alkyl group, an alkoxy group, a phenyl group, a phenoxy group, or combinations of two or more thereof, having 1 to about 10 or 1 to about 8 carbon atoms per group. R¹ can also be a substituted alkyl group. For example, R¹ can be a methyl group or higher alkyl and can be substituted with a halogen, an amine, or other functional group. Subscript x can be a number from about 1 to about 20 or from about 1 to about 10 and y can be a number from about 3 to about 20 or from about 3 to about 10. Such volatile siloxanes can have a molecular weight in the range of from about 50 and to about 1,000 and a boiling point less than about 300° C.

A solvent can be or comprise an aromatic hydrocarbon, alkane, alcohol, ketone, ester, ether, inorganic solvent, water, and combinations of two or more thereof such as, for example, xylene, benzene, toluene, n-heptane, octane, cyclohexane, dodecane, methanol, ethanol, isopropyl alcohol, acetone, methyl ethyl ketone, methyl isobutyl ketone, n-butyl acetate, t-butyl acetate, dipropylene glycol, dipropylene glycol methyl ether, methylene chloride, methylene dichloride, ethylene dichloride, carbon tetrachloride, chloroform, perchloroethylene, ethyl acetate, tetrahydrofuran, dioxane, white spirit, mineral spirits, naphtha, and combinations of two or more thereof.

Solvent selection depends on several factors, including, solubility of the components, that is, copolymer, functional silicone, and the optional components, catalyst and crosslinking agent, if added; the ability of the solvent to wet-out; and desired properties of the composition, such as evaporation rate of the solvent. It should be recognized that the solvent may be a combination of solvents. Those skilled in the art will be readily able to select the solvent based on these factors. Preferably, the solvent or combination of solvents will evaporate in about 3 minutes or less.

The release agent composition of this invention optionally further comprises a crosslinking agent. Preferably, the composition comprises a crosslinking agent. Compositions comprising a crosslinking agent generally have enhanced bonding to the surface of a substrate, compared with compositions lacking a crosslinking agent. Addition of a crosslinking agent also achieves other desired properties in a composition of this invention such as hardness, rapid forming of the coating, and non-reactivity toward the pattern or core box surface, thereby reducing or eliminating residues of the composition or foundry mix on said substrate.

Suitable crosslinking agents include functional silanes. A functional silane is a silane that contains a functional group which is reactive while preserving the organo-silane linkages. Such functional groups can be selected from the group consisting of hydroxy, alkoxy, carboxy, vinyl, hydrogen, amine, acrylate and methacrylate, and their derivatives.

Additional suitable crosslinking agents include a tetraalkyl titanate or a tetraalkyl zirconate having the formula of M(OR)₄ where M is titanium or zirconium and each R is independently an alkyl radical, a cycloalkyl radical, an aralkyl hydrocarbon radical, and combinations of two or more thereof in which each radical can contain, from about 1 to about 30, preferably from about 2 to about 18, more preferably, 2 to 12 carbon atoms per radical and each R can be the same or different. Suitable tetraalkyl titanates and tetraalkyl zirconates include, but are not limited to, tetraethyl titanate, tetrapropyl titanate, tetraisopropyl titanate, tetra-n-butyl titanate, tetra-2-ethylhexyl titanate, tetraoctyl titanate, tetraethyl zirconate, tetrapropyl zirconate, tetraisopropyl zirconate, tetra-n-butyl zirconate, tetra-2-ethylhexyl zirconate, tetraoctyl zirconate, and combinations of any two or more thereof. In particular embodiments, crosslinking agents include, but are not limited to, tetraisopropyl titanate and tetra n-butyl titanate.

The release agent composition optionally comprises a catalyst which can catalyze or enhance forming a coating derived from the release agent composition disclosed above. Examples include, but are not limited to, one or more zirconium compound, titanium compound, or combinations thereof. Suitable catalysts include, but are not limited to, those expressed by the formula M(OR)₄ , as described hereinabove, which also function as crosslinking agents. Specific examples of catalysts include, but are not limited to, zirconium acetate, zirconium propionate, zirconium butyrate, zirconium hexanoate, zirconium 2-ethyl hexanoate, zirconium octanoate, tetraethyl zirconate, tetra-n-propyl zirconate, tetraisopropyl zirconate, tetra-n-butyl zirconate, titanium acetate, titanium propionate, titanium butyrate, titanium hexanoate, titanium 2-ethyl hexanoate, titanium octanoate, tetraethyl titanate, tetra-n-propyl titanate, tetraisopropyl titanate, tetra-n-butyl titanate, and combinations of two or more thereof. These catalysts are commercially available. Preferred catalysts include tetraisopropyl titanate, tetra-n-butyl titanate, or a combination thereof

Other suitable catalysts include, without limitation, a Group VIII metal such as platinum, palladium, iron, rhodium, and nickel, or a complex thereof Suitable catalysts also include, without limitation, zinc and tin, and complexes thereof Examples of specific other suitable catalysts include, but are not limited to, dibutyltin diacetate, dibutyltin dilaurate, zinc acetate, zinc octanoate, and combinations of two or more thereof. For example, dibutyltin diacetate can be used independently or in combination with a titanium compound.

Each component disclosed above can be present in the composition of this invention in an effective amount sufficient to produce an effective mold release agent. The styrene-diene copolymer is typically present in an amount of 0.1 to about 30 wt % based on the total weight of the composition. Typically, the functional silicone is present in an amount of 0.01 to about 5 wt % based on the total weight of the composition.

Each of the crosslinking agents and catalysts disclosed above can be used in the composition in the range of from about 0.001 to about 10 wt % based on the total weight of the composition.

The specific amounts of the individual components will vary depending on their solubility and/or ability to disperse in the solvent in the presence of the other components, and performance of the coating, for example, the ability to provide multiple releases and prevent sticking of foreign matter to a surface.

The release agent composition can further comprise additional components such as modified fumed silica, surfactants, fluoropolymers such as polytetrafluoroethylene, waxes, fatty acids such as stearic acid, fatty acid salts such as metal stearates, finely dispersed solids such as talc, emulsifiers, biocides, corrosion inhibitors. These are typically present in an amount of 0.01 to about 10 wt % of the total release agent composition.

The composition can be produced by any means known to one skilled in the art such as, for example, mixing each component disclosed above.

The composition provides a coating with optional organic or inorganic fillers that forms a solid film upon application to the mold or pattern surface. The coatings of these embodiments form a solid film within about 10 minutes at temperatures of about 20° C. or higher.

The present invention provides a method to facilitate separation of a workpiece from a substrate. This method comprises applying a release agent composition comprising (a) a styrene-diene block copolymer; (b) a functional silicone; (c) a solvent; and optionally one or both of (d) a catalyst and (e) a crosslinking agent, to a surface of the workpiece, the substrate, or both. Once applied to a surface, the solvent evaporates, to form a surface coating. The substrate may comprise or consist of, but is not limited to, wood, metal, plastic, rubber, stone, cement, concrete, glass, fiber, tile and combinations of two or more thereof.

Application of the composition to a surface can also protect the surface by preventing foreign matter from sticking to surfaces coated with the composition. In this manner, the composition forms a coating which acts as a barrier or sealant.

The composition has excellent adhesion to polished surfaces, including metals, such as steel. The coating protects the surface of steel so that upon exposure to a corrosive environment, such as salt water, formation of rust is reduced or may be substantially eliminated. Thus, application of the release agent composition to a tooling surface, such as steel, can extend the life of the tooling surface.

In a particular application, there is a method to improve the release of molds removed from a pattern or cores from a core box, by applying the release agent composition to the pattern or core box and forming a coating. In this variation, the workpiece is the mold or core and the substrate is the pattern or core box. The composition acts as a mold release agent with excellent release qualities and allows for multiple reuses of the same pattern or core box to generate a large number of molds or cores. The composition as release agent can be used, according to this method, in various mold manufacturing processes, including the air-set or no-bake process, the carbon dioxide process, and the cold box process.

A mold or pattern can be made from any composition useful as a foundry mix. A typical mix comprises sand, a binder and, optionally, a catalyst. Other suitable aggregate materials can be used in combination with, or in place of, the sand in the foundry mix, such as for example, zircon, aluminosilicates and the like. Selection of the particular binder will generally depend on the mold manufacturing method and gaseous reagent employed, if the cold box method is used. Preferred combinations of gaseous reagent/binder are known to those skilled in the art.

While the discussion of mold-forming processes below presents cold box and no bake processes as examples, the selection of these illustrations is not intended to imply any limit to the processes to which compositions of the various embodiments of the invention are applicable.

In a cold box process, the method comprises (a) applying a composition comprising a styrene-diene copolymer, a functional silicone, a solvent and optionally one or both of a catalyst and crosslinking agent to a surface of a pattern or core box, forming a coating on the surface of the pattern or core box; (b) molding a foundry mix into the desired shape by shaping to the pattern or charging to the core box; and (c) contacting the foundry mix with a volatile curing agent. Secondary or tertiary amines or sulfur dioxide are examples of volatile curing agents.

In a no bake process, the method comprises (a) applying a composition comprising a styrene-diene copolymer, a functional silicone, a solvent and optionally one or both of a catalyst and crosslinking agent to a surface of a pattern or core box, forming a coating on the surface of the pattern or core box; (b) molding a foundry mix comprising sand and a binder into the desired shape by shaping to the pattern or charging to the core box; and (c) curing the binder.

Also provided is a substrate, which is a pattern or core box, comprising a surface or a portion of the surface having a coating derived from a composition comprising a styrene-diene copolymer, a functional silicone, a solvent and optionally, one or both of a catalyst and crosslinking agent. Advantageously, a pattern or core box comprising a coating derived from a release agent composition according to the invention, may retain the coating when exposed to pressure of at least 40 psi (276 kPa), or at pressure of at least 60 psi (414 kPa) or at pressure of at least 75 psi (517 kPa) or at pressure of at least 100 psi (689 kPa). Such pressures are common to those used in the foundry industry. By “retains the coating” it is meant the pattern or core box can be reused to provide multiple releases with substantially the same release properties after exposure to the pressure.

### EXAMPLES

### Example 1

A mixture of 0.25 g of KRATON G-1651 styrene-diene block copolymer, available from Kraton Polymers, Houston, Tex., 8.3 g n-butyl acetate, and 1.45 g SHELLSOL A100 aromatic hydrocarbon solvent, available from Shell Chemicals, Houston, Tex., was heated gently to dissolve the polymer and form a homogeneous solution. Once the polymer dissolved, 0. 1 g DOW CORNING 3-0084 functional silicone fluid, available from Dow Corning, Midland, Mich., 0.05 g tris(cyclohexylmethylamino)silane, and 0.04 g tetra n-butyl titanate, available from E. I. du Pont de Nemours and Company, Wilmington, Del., were added. The mixture was agitated until a homogenous consistency was achieved. The solution was sprayed out onto a carbon steel plate and uniform wetting was observed. The solvent was allowed to evaporate, forming a coating on the plate and subsequent testing was performed after this time. The release properties and abrasion resistance of the coating were tested as described below and results are provided in Table 1.

### Example 2

A mixture of 0.25 g of KRATON G-1651, 8.3 g n-butyl acetate, and 1.45 g SHELLSOL A100 was heated gently to dissolve the polymer and form a homogeneous solution. Once the polymer dissolved, 0.08 g DOW CORNING 1-9770 functional silicone fluid, available from Dow Corning, Midland, Mich., 0.05 g DOW CORNING Z-6018 functional silicone resin, available from Dow Corning, Midland, Mich., and 0.04 g titanium acetyl acetonate, available from E. I. du Pont de Nemours and Company, Wilmington, Del., were added. The mixture was agitated until a homogenous solution was achieved. The solution was sprayed out onto a carbon steel plate and uniform wetting was observed. The solvent was allowed to evaporate forming a coating on the plate and subsequent testing was performed after this time. The release properties and abrasion resistance of the coating were tested as described below and results are provided in Table 1.

### Example 3

A mixture of 0.25 g of KRATON G-1651, 8.3 g n-butyl acetate, and 1.45 g SHELLSOL A100 was heated gently to dissolve the polymer and form a homogeneous solution. Once the polymer dissolved, 0.05 g DOW CORNING 3-0084 functional silicone fluid, 0.1 g DOW CORNING 1-9770 functional silicone fluid, 0.05 g tris(cyclohexylmethylamino)silane, and 0.04 g titanium acetyl acetonate were added. The mixture was agitated until a homogenous consistency was achieved. The solution was sprayed out onto a carbon steel plate and uniform wetting was observed. The solvent was allowed to evaporate forming a coating on the plate and subsequent testing was performed after this time. The release properties and abrasion resistance of the coating were tested as described below and results are provided in Table 1.

### Example 4

A mixture of 0.20 g of KRATON G-1651, 7.8 g t-butyl acetate, and 2.00 g SHELLSOL A100 was heated gently to dissolve the polymer and form a homogeneous solution. Once the polymer dissolved, 0.14 g DOW CORNING 1-9770 functional silicone fluid, 0.07 g DOW CORNING Z-6018 functional silicone resin, and 0.08 g n-butyl titanate were added. The mixture was agitated until a homogenous consistency was achieved. The solution was sprayed out onto a carbon steel plate and uniform wetting was observed. The solvent was allowed to evaporate forming a coating and subsequent testing was performed after this time. The release properties and abrasion resistance of the coating were tested as described below and results are provided in Table 1.

### Example 5

A mixture of 0.17 g of KRATON G-1651, 7.90 g methylisobutyl ketone, and 1.90 g SHELLSOL A100 was heated gently to dissolve the polymer and form a homogeneous solution. Once the polymer dissolved, 0.14 g DOW CORNING 1-9770 functional silicone fluid, 0.08 g DOW CORNING Z-6018 functional silicone resin, and 0.04 g n-butyl titanate were added. The mixture was agitated until a homogenous consistency was achieved. The solution was sprayed out onto a carbon steel plate and uniform wetting was observed. The solvent was allowed to evaporate forming a coating on the plate and subsequent testing was performed after this time. The release properties and abrasion resistance of the coating were tested as described below and results are provided in Table 1.

### Comparative Example A

Use of a non-functional silicone. A mixture of 0.50 g of KRATON G-1650, available from Kraton Polymers, Houston, Tex., and 9.5 g toluene was agitated gently to dissolve the polymer and form a homogeneous solution. Once the polymer dissolved, 0.1 g DOW CORNING 203 silicone fluid, available from Dow Corning, Midland, Mich., was added. The mixture was agitated until a homogenous consistency was achieved. The solution was sprayed out onto a carbon steel plate and uniform wetting was observed. The solvent was allowed to evaporate forming a coating on the plate and subsequent testing was performed after this time. The release properties and abrasion resistance of the coating were tested as described below and results are provided in Table 1.

### Comparative Example B

Absence of styrene-diene block copolymer. A mixture of 7.79 g methylisobutyl ketone, and 1.95 g SHELLSOL A100, 0.14 g DOW CORNING 1-9770 functional fluid, 0.08 g DOW CORNING Z-6018 functional silicone resin, and 0.04 g n-butyl titanate was agitated until homogenous. The solution was sprayed out onto a carbon steel plate. The solution wet the surface poorly and non-uniform wetting was observed. The solvent was allowed to evaporate forming a coating on the plate and subsequent testing was performed after this time. The release properties and abrasion resistance of the coating were tested as described below and results are provided in Table 1.

### Comparative Example C

Absence of silicone. A mixture of 0.50 g of KRATON G-1651, 7.13 g n-butyl acetate and 2.35 g SHELLSOL A100 was heated gently to dissolve the polymer and form a homogeneous solution. The solution was sprayed out onto a carbon steel plate and uniform wetting was observed. The solvent was allowed to evaporate forming a coating on the plate and subsequent testing was performed after this time. The release properties and abrasion resistance of the coating were tested as described below and results are provided in Table 1.

### Test Methods and Results

Release characteristics were tested using 3M SCOTCH tape. The tape was attached to a carbon steel plate coated with the compositions of Examples 1-6. The tape was removed from the plate and rated as follows:
1—Tape is easily removed from the surface with excellent release and coating remaining intact.
2—Tape is easily removed from the surface with good release and coating remaining intact.
3—Tape adheres to surface, but is still able to be removed and coating remains intact.
4—Tape adheres to surface, is still able to be removed, but coating does not remain intact and begins to lift from the surface.
5—Tape adheres to surface, is difficult to remove, and completely removes coating from surface.

Abrasion resistance of the coatings was tested using a bead blaster, available from Econoline, Grand Haven, Mich. The maximum pressure of the bead blaster was 120 psi (827 kPa) and the minimum pressure was 5 psi (34 kPa), set at 65 psi (448 kPa) pressure. The bead blaster is a self-contained unit delivering beads through a high-pressure air nozzle capable of removing coatings/rust/paint from a desired surface. The air pressure can be adjusted using a regulator connected to the bead blaster cabinet.

Size D 50-70 US Sieve beads were used. The bead blaster was held from 1 inch (25.4 mm) to 1.5 inches (38 mm) from the steel plate being tested. The diameter of the nozzle through which the air was blown was about 3/16 inch (4.8 mm). The nozzle was slowly moved from right to left across the plate being tested. Each of the carbon steel plates coated with the compositions of Examples 1-6 were tested. Following bead blasting, each plate was rated as follows:
1—Coating remains intact after bead blasting and cannot be rubbed off.
2—Coating remains intact after bead blasting, cannot be removed with a light brush, but can be removed with vigorous rubbing.
3—Coating remains intact after bead blasting, cannot be removed with a light brush, but can be removed upon light rubbing.
4—Coating remains intact after bead blasting, but can be removed with a light brush.
5—Coating does not survive bead blasting.

TABLE 1
Summary of release properties and abrasion resistance.

| Example | Tape release^{a} | Bead blasting^{b} |
|---|---|---|
| 1 | 3 | 2 |
| 2 | 2 | 2 |
| 3 | 1 | 2 |
| 4 | 3 | ND^{c} |
| 5 | 1 | 1 |
| Comparative A | 3 | 4 |
| Comparative B | 3 | 3 |
| Comparative C | 5 | 2 |

^{a}Release characteristics of the coatings were tested using 3M SCOTCH tape.
^{b}Abrasion resistance of the coatings was tested using an Econoline bead blaster set at 65 psi (448 kPa) pressure.
^{c}ND = not determined.

As can be seen from Table 1, the release agent compositions of this invention provide superior performance in terms of improved tape release and/or bead blasting. The Comparative Examples (A-C) lack one of the essential components in contrast to Examples 1-5.

The foregoing specification and examples illustrate various embodiments of compositions that provide an abrasion resistant coating that facilitates the clean, low friction release of patterns from molds and cores, workpieces from dies, tools and machine components, and that have other industrial lubricant uses. Proper application of these compositions can provide enhanced life of patterns, dies, tools and machine components, reduced scrap and other waste, improved sand core and casting quality, and lower emissions of volatile materials that are detrimental to the environment.

1-15. (canceled)

16. A method to facilitate separation of a workpiece from a substrate comprising applying a release agent composition comprising (a) a styrene-diene block copolymer; (b) a functional silicone; and (c) a solvent to a surface of the workpiece, the substrate, or both and evaporating the solvent to form a surface coating.

17. The method of claim 16 wherein the composition further comprises one or both of (d) a catalyst and (e) a crosslinking agent.

18. The method of claim 17 wherein the workpiece is a mold and the substrate is a pattern or the workpiece is a core and the substrate is a core box.

19. The method of claim 17 wherein the substrate is wood, metal, plastic, rubber, stone, cement, concrete, glass, fiber, tile, or combination of two or more thereof.

20. The method of claim 17 wherein the substrate is metal and the metal is steel.

21. A method for forming a mold in a cold box process which comprises (a) applying a composition comprising a styrene-diene copolymer, a functional silicone, a solvent and one or both of a catalyst and crosslinking agent to the surface of a pattern or core box and evaporating the solvent to form a surface coating; (b) molding a foundry mix into the desired shape by (1) shaping to the pattern or (2) charging to the core box; and (c) contacting the foundry mix with a volatile curing agent.

22. A method for forming a mold in a no bake process which comprises (a) applying a composition comprising a styrene-diene copolymer, a functional silicone, a solvent and one or both of a catalyst and crosslinking agent to the surface of the pattern or core box and evaporating the solvent to form a surface coating; (b) molding a foundry mix comprising sand and a binder into the desired shape by (1) shaping to the pattern or (2) charging to the core box; and (c) curing the binder.

23. A substrate comprising a surface coating derived from a composition comprising a styrene-diene copolymer, a functional silicone, a solvent and one or both of a catalyst and crosslinking agent, wherein the substrate is a pattern or a core box.

24. The substrate of claim 23 wherein the coating is retained when the coating is exposed to pressure of at least 40 psi (276 kPa).

25. The substrate of claim 24 wherein the coating is retained when the coating is exposed to pressure of at least 60 psi (414 kPa).

26. The substrate of claim 25 wherein the coating is retained when the coating is exposed to pressure of at least 75 psi (517 kPa).

27. The substrate of claim 26 wherein the coating is retained when the coating is exposed to pressure of at least 100 psi (689 kPa).
